(19) United States
(12) Patent Application Publication
(10) Pub. No.: US 2010/0307954 A1
(43) Pub. Date: Dec. 9, 2010

(54) BASIC CONTAINER AND CONTAINER COMPRISING A TOP CUP AND THE BASIC CONTAINER

(76) Inventors: Danny De Bruyn, Roosdaal (BE); Henk De Groot, Hoeven (NL)

Correspondence Address: BACON & THOMAS, PLLC, 625 SLATERS LANE, FOURTH FLOOR, ALEXANDRIA, VA, 22314-1176, US

(21) Appl. No.: 12/865,024

(22) PCT Filed: Nov. 14, 2008
(86) PCT No.: PCT/EP08/65558

§ 371 Date: Jul. 28, 2010

(30) Foreign Application Priority Data
Jan. 29, 2008 (BE) 2008-0056

(51) Int. Cl. B65D 85/00; B29C 49/06; B65D 25/28; B65D 6/00

(52) U.S. Cl. 206/524.6; 264/537; 220/752; 220/4.28

(57) ABSTRACT

A basic container comprising a top, a substantially flat bottom and at least three substantially flat sides at an angle of substantially 90° with respect to the bottom, the basic container being leak-free except for a container head in the top with a filling/emptying opening and a means for providing a leak-free closure with a closure means, wherein the axis of the container head is at an acute angle with respect to the bottom; a process for the manufacturing thereof; a top cup adapted to be attachable to the top of the above-described basic container without obstructing the filling/emptying opening of the container head of the basic container; and a plastic container comprising the above-described basic container and the above-described top cup attached with attachable means to the basic container, wherein the top cup does not obstruct the opening of the container head.

### FIELD OF THE INVENTION

The present invention relates to plastic containers that are manufactured by a blowing process, e.g. with a handle and spout, as well as the manufacturing methods and tools therefore.

### BACKGROUND OF THE INVENTION

Liquids, powders, pastes etc. are packed or stored in containers of very divergent size and shape. Such containers can be made of glass, plastic or metal or possibly a combination of these materials.

A plastic container can be manufactured by extrusion blowing or by blowing a preform. In extrusion blowing a plastic tube, comprising one or more layers is blown using gas pressure and under particular thermal conditions against a die (mould). The die consists of a number of parts that can slide apart to remove the thereby formed container.

In the blowing of the preform, the preform is first injection-moulded with an injection moulding apparatus. Often an injection moulding apparatus is used which is specifically equipped and set up for the injection moulding of preforms. Often a large number of preforms can be injection moulded at the same time. In a second step the preform is partially warmed and blown. In the part that is heated and blown the wall thickness decreases.

U.S. Pat. No. 4,257,525 discloses a bottle having a neck finish at one end, a base at its other end and a sidewall therebetween, comprising: a recess in said sidewall which forms a space for finger placement in said sidewall and within said recess, and, attachment means on said sidewall at said recess receiving a handle having attachment means thereon which coact with said recess attachment means to secure said handle to said bottle said handle extending essentially within and bridging said recess and about which finger placement can occur within said recess for lifting, carrying and pouring from the bottle by gripping said attached handle.

U.S. Pat. No. 4,372,454 discloses a plastic container formed from a preform having a neck portion and an expanded blown portion wherein the neck portion remains constant in size during blowing and wherein the expanded blown portion has a sidewall extending from the neck portion, comprising: attachment means integral with and on the sidewall, a handle including a ring intermediate the ends of the neck portion which is integral with and which extends substantially about the neck portion that remains substantially constant in size during expansion, and a projection positioned substantially within the breadth of the container which has a substantially horizontal portion integral with and extending from said ring, and a substantially vertical portion depending from said horizontal portion that has attachment means thereon which coact with said integral attachment means on said sidewall for affixing said depending portion thereto, to thereby provide a handle for gripping, lifting and pouring, wherein the stresses resulting therefrom are distributed about said ring.

US 2007/0095785A1 discloses a synthetic resin bottle with a handle, comprising: a bottle; and a handle comprising a grip disposed in the upper rear portion of said bottle, an upper arm extending forward from upper end of said grip, and a pair of lower arms that extends to the right and the left from lower end of said grip and pinch body of the bottle from both sides, wherein fore-end of said upper arm is fitted and secured firmly to neck ring formed in the lower portion of neck of said bottle by undercut engagement with the neck ring; and wherein fore-ends of the pair of said lower arms are fitted and secured to bases of a pair of raised portions disposed on both sidewalls of the body of the bottle similarly by the undercut engagement with said raised portions.

U.S. Pat. No. 4,899,885 discloses a plastic container for pourable material comprising a hollow body having a bottom surface, upstanding side walls extending upwardly from the bottom surface, a top wall connected to and closing the side walls, and a pouring/filling neck protruding upwardly from the top wall, a stacking attachment piece fitted onto the top of the hollow body and presenting an upper surface lying above the pouring/filling neck which is complementary to the bottom surface, and carrying handle means for detachably connecting the stacking attachment piece to the hollow body.

WO 2004/035413A discloses a handle for a closure for closing an opening of a container, said handle comprising an engaging part with engaging means for engaging with the closure, and a handling part pivotally connected to the engaging part so as to allow the handling part to be folded into a folded configuration and unfolded into a non-folded configuration in relation to the engaging part, wherein the engaging means is adapted to establish a fixed engagement with the closure. WO 2004/035413A further discloses a handle for handling a container having a container body part and a neck portion, said handle comprising an engaging part with engaging means for engaging with the neck portion, a handling part pivotally connected to the engaging part so as to allow the handling part to be folded into a folded configuration and unfolded into a non-folded configuration in relation to the engaging part, the handling part extending further outwardly from the container in the non-folded configuration than in the folded configuration, wherein an opening is defined within the handling part, said opening being of a size allowing the neck portion to be received within the opening when the handling part is in the folded configuration.

Typically PET drink bottles are manufactured by injection moulding of a preform in which the definitive form of the top of the bottle with the screw thread for the screw top is already provided. The rest of the bottle obtains its definitive form by blowing a part of the preform. A variant of the technology of blowing a preform, consists of removing part of the form after blowing. In this way PET beakers are made with an open side by cutting away the non-blown part of the container.

Both the technique of extrusion blow moulding and the technique of the blowing of preforms, have advantages and disadvantages.

Complicated shapes can be realized by extrusion blow moulding such as stackable or non-stackable containers provided or not with a handle. Known examples thereof are containers with a content of 5 L which are typically used for e.g. white spirit or chlorinated water, 3 L bottles for fabric softener, . . . . Such containers are not made by blowing moulding a preform because a hollow handle is integrated into the shape of the container. The product flows through the handle and on the outside at least several fingers can encircle the handle.

More robust PET containers with the same weight and/or more transparent and/or cheaper than blow-moulded containers can be manufactured by injection moulding and blow-moulding of a preform. In the blow-moulding process the plastic material of the preform is stretched and thinned. Stretching in two directions with additional thinning in the third direction is only possible to a limited extent depending upon the PET material and its additives.

### SUMMARY OF THE INVENTION

The present invention concerns, in one aspect, a basic container, a top cup and a container comprising the basic container and the top cup attached thereto and processes for manufacturing the basic containing and the top cup.

The present invention embraces containers whereby the container head and/or inlet/outlet and/or filling/emptying opening, which is part of the basic container, is directed at an angle to the outside.

The invention disclosed in this patent also concerns, in another aspect, plastic containers, which are manufactured by the joining of two separate parts. Hence, an aspect of this invention is to provide a synthetic resin bottle with a handle that can be manufactured at a low cost and can be used reliably. An advantage of the present invention is the creation of a handle of a simple fitting structure, in which the handle is capable of dispersing the load stably and is easy to mold and assemble.

In embodiments of the present invention, a top cup is slipped over the container head and is secured onto the basic container, e.g. by a clickable connection. A handle is preferably integrated into the top cup. In the case of mechanical stress on the top cup, such as picking up the container by the handle integrated into the top cup, the top cup is spanned or locked between the click connection and the container head with a greatly reduced or without any danger of its coming loose.

Aspects of the present invention are realized by a basic container comprising a top, a substantially flat bottom and at least three substantially flat sides at an angle of substantially 90° with respect to the bottom, the basic container being leak-free except for a container head in the top with a filling/emptying opening, wherein the axis of the container head is at an acute angle with respect to the bottom. A means for providing a leak-free closure to the filling/emptying opening, wherein the axis of the container head is at an acute angle by means of a closure means is preferred. The basic container is preferably made by injection blow moulding or injection stretch blow moulding.

Aspects of the present invention are also realized by a process for manufacturing a basic container having a top, a substantially flat bottom and at least three substantially flat sides at an angle of substantially 90° with respect to the bottom, the basic container being leak-free except for a container head in the top with a filling/emptying opening, the process comprising the steps of: injection moulding a preform comprising the container head; placing the preform in a mould at an acute angle with respect to the preform; axially stretching the non-container head part of the preform towards or to the bottom of the mould; blow moulding the stretched part of the preform to the mould to provide the basic container. A blow moulded product of this type does not have to have weld lines along the side bottom or top to form the container, i.e. does not have weld lines generated during the blowing process. Weld lines can be a source of weakness.

Aspects of the present invention are also realized by a top cup adapted to be attachable to the top of the basic container or produced by a process according to the invention without obstructing the filling/emptying opening of the container head of the basic container.

Aspects of the present invention are also realized by a plastic container comprising the above described basic container and the above-described top cup attached with attachable means to the basic container, wherein the top cup does not obstruct the opening of the container head.

Further embodiments of the present invention are disclosed in the detailed description.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to the devices consisting only of components A and B. It means that with respect to the present invention, the only relevant components of the device are A and B.

### DEFINITIONS

The term “container”, as used in disclosing the present invention, is to be understood: bottle, flask, water bottle, pot, beaker, vat (cask, barrel), pitcher (jug), . . . and other terms used as more specific names for container. Often the different terms are connected with an external feature of the container or with the product that is mostly stored in the container. One refers to a lemonade bottle; a bottle, a water bottle or a jug of water or a pot of mayonnaise; a ketchup bottle or pot; a small spice jar, . . . . Characteristic thereof to is that in such containers an opening is provided for putting into or taking out product.

The term “product”, as used in disclosing the present invention, means liquids, powders, pastes . . . which are packed or stored in these containers. Examples are drinks, liquid washing products, degreasing products, lubricants, wood protection products, fabric softeners, liquid care products, creams, cleaning liquids, chocolate pastes (spreads), jam, peanut butter, ground spices, ground coffee beans, and vinegar whether or not with submerged edible products.

The term “polyester”, as used in disclosing the present invention, includes polyester with optional additives.

The term “top cup”, as used in disclosing the present invention, means an adaptive element with attaching means necessary to convert the basic container into a stackable plastic container and/or to provide the basic container with a grip or handle.

The term “basic container”, as used in disclosing the present invention, means the function part of the plastic container containing the product.

The term “container head”, as used in disclosing the present invention, means the non-blown part of the preform providing an opening for the filling/emptying of the basic container.

The term “preform”, as used in disclosing the present invention, means forming; e.g. by injection moulding, a plastic form which is intended for use in injection blow moulding. Often an injection moulding apparatus is used which is specifically equipped and adjusted for the injection moulding of preforms. Often a large number of preforms can be injection moulded at the same time.

The term “extrusion blow moulding”, as used in disclosing the present invention, means a process in which a hot tube of plastic material, comprising one or more layers, is dropped from an extruder and captured in a water-cooled mould. Once the moulds are closed, air is injected through the top or neck of the container. When the hot plastic material is blown up and touches the walls of the mould the material “freezes” and the container now maintains its rigid shape.

The term “injection blow moulding”, as used in disclosing the present invention, means a process in which material is injection moulded and then the hot material still on the core pin is then indexed to the blow moulding station where it is blown in a bottle and allowed to cool. Injection blow moulding has the advantage of providing containers that have close tolerance in threaded necks, wide mouth openings; solid handles, and highly stylized shapes. The mould (die) consists of a number of parts that can slide apart to remove the container formed.

The term “injection stretch blow moulding”, as used in disclosing the present invention, means a four-step process. In the first step, the pre-form molding step, molten polymer flows into a cavity such as an injection cavity via, for example, a hot runner block, to produce the desired shape of the preform with a mandrel (the core pin) producing the inner diameter and the injection cavity the outer, the opening providing the opening with closure provision of the injection stretch blow moulded object. After a set time the injection moulds and core pins part and the preform held in a neck carrier is rotated 90°. Once conditioned to the correct temperature the preform is ready for STRETCHING and BLOWING to the finished shape. Once the preform is within the BLOWMOULD area the moulds close, a stretch rod is introduced to stretch the preform longitudinally and using two levels of air pressure, the preform is blown circumferentially e.g. via the stretch rod. After a set time for cooling the moulds open and the preform is removed via drop chutes or robotics. In practice the four stages are carried out concurrently using a revolving carousel of moulds. The wall thickness decreases both during the stretching step and during the blowing step.

The term substantially flat bottom, as used in disclosing the present invention, means having at least 70% of the surface of the bottom external to the basic container on the same plane and having no substantial protuberances on the external surface of the bottom.

The term “eccentric”, as used in disclosing the present invention, means non-centric or off-centre.

The term “weld-less”, as used in disclosing the present invention, means not containing a weld, e.g. a hot weld between plastic elements or sheets.

The term “seamless”, as used in disclosing the present invention, means not having a seam.

### BRIEF DESCRIPTION OF THE DRAWINGS

FIG. 1: 5 L PET container showing attaching of top cup to the basic container and stacking of containers according to an embodiment of the present invention.

FIG. 2: Basic container illustrating container head with screw thread and indentations in top thereof according to an embodiment of the present invention, and

FIG. 3: Top cup illustrating stackable edge (2), handle (3), ring-formed zone (4) and hook-formed zone (6) according to an embodiment of the present invention.

FIG. 4a: Relationship between the original preform with that part subject to stretch blow moulding shown by dashed lines and the final basic container with the preform at an angle, e.g. of 75.5° with respect to the bottom of the basic container.

FIG. 4b: Shows the preform at an angle, e.g. of 75.5° in the mould into which it is stretch blow moulded to form the basic container.

### PLASTIC CONTAINER

Aspects of the present invention are realized by a plastic container comprising the basic container, according to the present invention. Embodiments include a top cup, according to the present invention, attachable with attachment means to the basic container, wherein the top cup preferably does not obstruct the opening of the container head.

The invention is primarily applicable for containers produced with PET material, optionally with additives, without excluding other plastic materials that are suitable for the process described. The invention provides plastic containers with a complicated shape such as stackable containers and containers with an integrated handle. The containers are produced by the blow-moulding of a preform to a basic container, and forming of a so-called top cup, e.g. by injection moulding. Optionally the top cup may be mounted on the basic container or the two parts may be delivered for joining on site. Preferably, the top cup only comes into contact with the outside of the basic container and does not come into contact with the product. The invention is particularly useful for containers with a capacity of 0.5 L to 50 L e.g. 1.5 L to 30 L, whereby one handle or at least one handle per container provides added value and/or whereby a good stackability on each other provides added value. The relatively complicated form, which is required due to the provision of a handle or to provide stackability can be realized in PET material (or other suitable material) thanks to the present invention. An advantage of embodiments of the present invention is the provision of a lighter container than existing containers with comparable capacity, comparable shape, comparable strength and stability. In addition the PET (or other suitable material) container is more transparent and cheaper.

The constituent parts of the container can be manufactured out of the same material, materials which only differ in colour for example, PET materials with different additives or possibly even from different materials. It is even possible to form, e.g. by injection moulding, the top cup from recycled material, including waste material from the production of the basic container. The so-called top cup, which is comprised in embodiments of the present invention, can be attached to the basic container in different ways.

Without excluding other attachment methods the present invention comprises the use of a ring-shaped zone of the top cup which is slipped over the container head of the basic container.

The basic container may be provided with a click-opening and the top cup may be provided with a click-hook, or vice versa. More generally, in accordance with embodiments of the present invention, a mechanical attachment means is provided between the top-cup and the basic container. These attachment means can be a two-point or three-point or multi-point connection. For example, another zone of the top cup can click onto the basic container. The attachment means can also include a surface connection means, e.g. an alternative attachment method consists of the use of adhesive, whereby a zone of the top cup with appropriate shape is glued to the basic container.

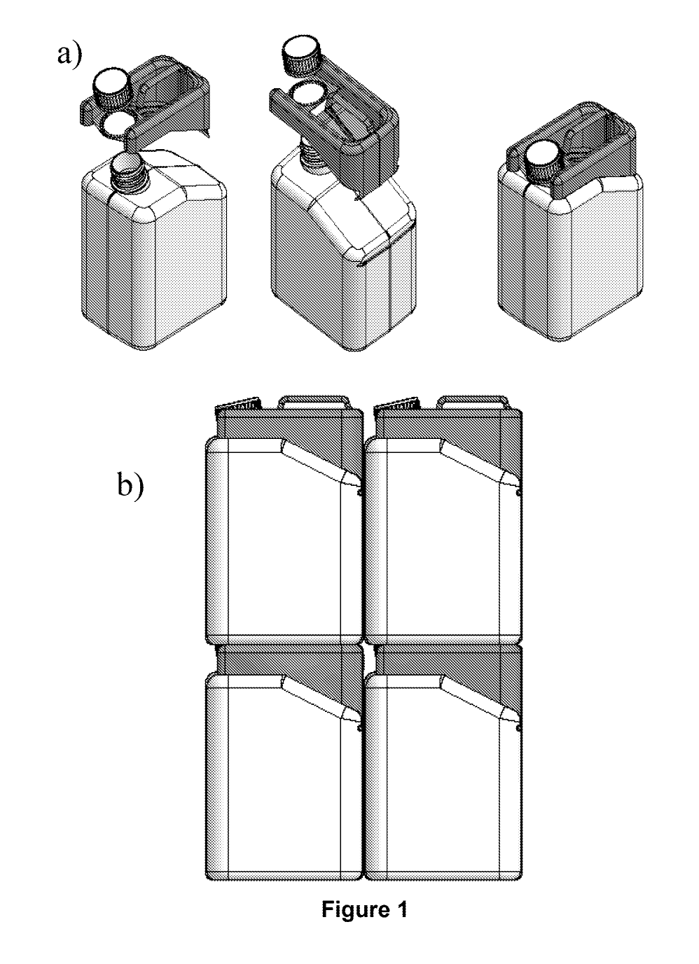

In FIG. 1 a container is, for example, suitable for a capacity of 5 L. In FIG. 2 the basic container is represented. The container head (1) serves at the same time as opening for filling and emptying the container and for the receipt of a separate screw top. The container head approximates to the non-blow-moulded part of the preform. The axis of the container head forms, for example, an angle of 20° to the vertical.

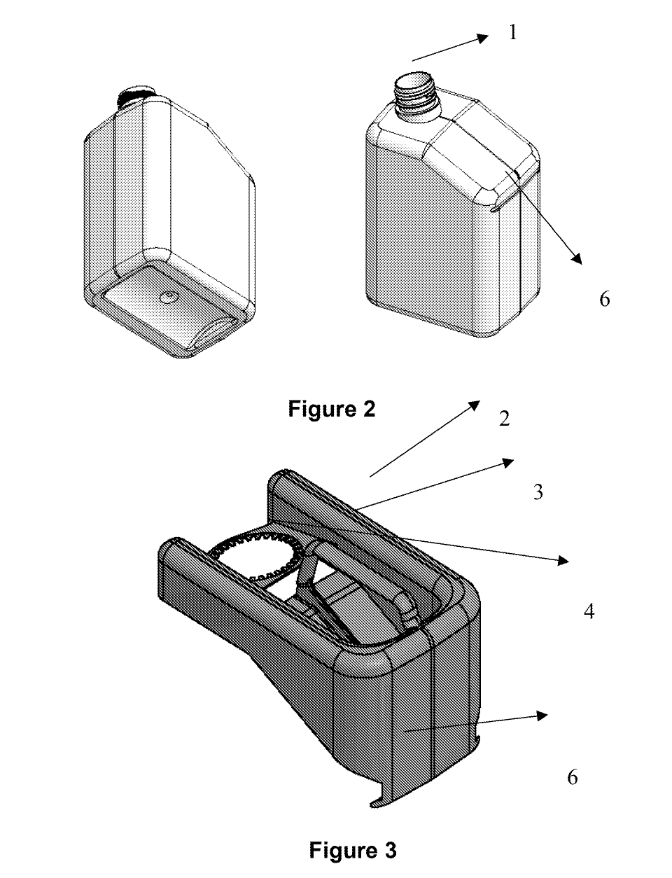

In FIG. 3 the top cup is represented, which in this case is provided with an edge (2) making the container stackable, a handle (3), a ring-shaped zone (4) which is slipped over the container head of the basic container, a ring to ensure the right of first use, a hook-shaped zone (5) which clicks in an indentation (6) of the basic container. Upon picking up the complete container, both empty and filled, by the handle (3), the top cup must lengthen considerably in order to come loose from the basic container. Experiments have shown this does not happen, even if the container is raised by the handle at an acceleration of 20 m/s². The complete container of this example is manufactured from the same PET material, has a mass of 120 g and can afterwards be completely ground up for recycling.

According to a first embodiment of the plastic container, according to the present invention, the attaching means is gluing and/or at least one crimp connection and/or at least one shape-closed connection.

According to a second embodiment of the plastic container, according to the present invention, the shape-closed connection is a click-connection.

According to a third embodiment of the plastic container, according to the present invention, the basic container and top cup are completely from PET material optionally with additives, optionally with colorants.

According to a fourth embodiment of the plastic container, according to the present invention, the plastic container comprising a basic container and a top cup, the basic container being manufactured by blow-moulding of part of an injection-moulded preform and is leak-free outside a filling opening and the top cup being manufactured by injection moulding and being attached to the basic container.

According to a fifth embodiment of the plastic container, according to the present invention, the basic container is provided with a sticking-out part provided for the receipt of a closure or provides the possibility of filling and emptying of the container, and wherein the top cup is attached to the basic container by slipping an opening provided in the top cup over the sticking-out part of the basic container and to attach via another zone of the top cup to the container via gluing, via a crimp connection or via a shape-closed connection such as a click connection.

According to a sixth embodiment of the plastic container, according to the present invention, the top cup is attached to the basic container by allowing a number of hook-shaped protrusions on the top cup to grip in zones with appropriate shape provided in the basic container; wherein a number of such zones in which connections can be realized function as click connections; and wherein in realizing the connection or to ensure connection, although unnecessary in the case of appropriate shape of the basic container and top cup, use can be made of crimping or gluing.

According to a seventh embodiment of the plastic container, according to the present invention, the basic container is manufactured by blow-moulding of part of a preform; the non-blow-moulded part of the preform can be used for receipt of a closure or for filling or emptying of the container; the non-blow-moulded part of the preform is positioned eccentrically and under an acute angle with the vertical; the top cup is attached to the basic container by slipping an opening provided in the top cup over the non-blow-moulded part of the preform and attaching via another zone of the top cup to the container by means of a shape-closed connection, particularly via hook-shaped protrusions provided on the top cup which hooks into indentations provided therefor in the basic container.

According to an eighth embodiment of the plastic container, according to the present invention, a zone of the top cup is slipped over the non-blow-moulded part of the preform and wherein another zone of the top cup is attached to the basic container via a click connection.

According to a ninth embodiment of the plastic container, according to the present invention, the top cup is provided with an opening which is slipped over the non-blow-moulded part of the basic container, and wherein the opening is provided with a ring which ensures the first use of the container.

According to a tenth embodiment of the plastic container, according to the present invention, the top cup is provided with an opening which is slipped over the non-blow-moulded part of the basic container, and wherein the opening is provided with lips through which the top cup is elastically clamped between the non-blow-moulded part of the basic container and the other attachment points of the top cup.

According to an eleventh embodiment of the plastic container, according to the present invention the top cup is characterized by the presence of a functional element such as a handle that can be encircled by at least one finger, or characterized by the presence of support points or support ribs that make the container stackable.

### Basic Container

Aspects of the present invention are realized by a basic container comprising a top, a substantially flat bottom and at least three substantially flat sides at an angle of substantially 90° with respect to the bottom, the basic container being leak-free except for a container head in the top with a filling/emptying opening and a means for providing a leak-free closure with a closure means, wherein the axis of the container head is at an acute angle with respect to the bottom. The junctions of the bottom with the sides, the sides with one another and the sides with the top are preferably rounded to ensure maximum strength.

The inside of the basic container comes into contact with the product. The basic container comprises a non-blow-moulded zone of the preform, termed the container head, which is intended for the emptying or filling of the container and is provided with a closure, optionally with a screw thread. When the top cup, comprised in the present invention, includes a functional element such as a handle, it is often advantageous to position the handle above the centre of gravity or as close as possible above the centre of gravity. The container head must then be provided eccentrically. Usually this means that the preform must be blow-moulded eccentrically. In view of the restrictions on the stretching attainable with a particular material, it is often advantageous to position the preform at an angle in respect of the definitive container, in particular with the top side to the outside. This means that the axis of the not yet blow-moulded part of the preform, which is mostly used for the reception of a screw top and serves as the filling opening, is at an angle in the definitive container. This is, moreover, often advantageous for the emptying of the container.

The blow-moulded zone of the preform may be symmetrical or asymmetrical. An asymmetrical blow-moulded zone of the preform can ensure a more homogeneous wall thickness and compensate for the asymmetrical blowing process.

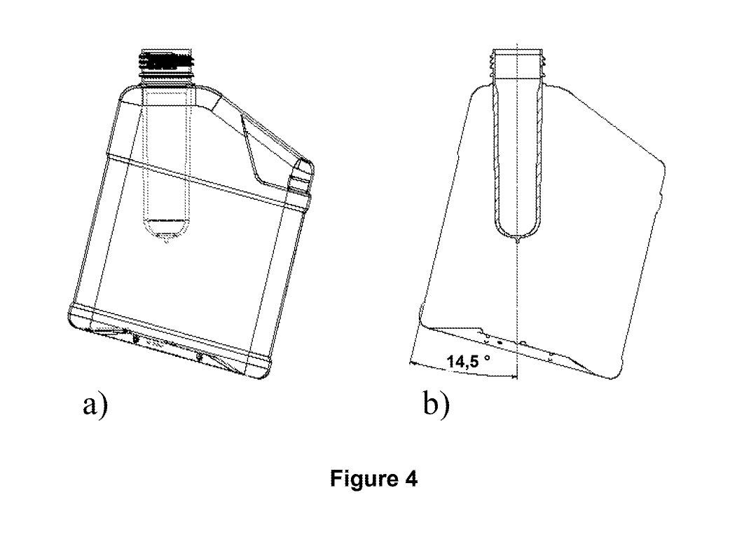

According to a first embodiment of the basic container, according to the present invention, the axis of the container head is at an acute angle with respect to the bottom, e.g. at an angle of less than 85° with respect to the bottom, with an angle of less than (or optionally close to) 75° with respect to the bottom being preferred and an angle of 70° with respect to the bottom being particularly preferred. An angle of greater than 30°, e.g. greater than 45° with respect to the bottom is also useful. As the angle between the axis of the container head and the bottom increases and/or the eccentricity of the container head in the top increases the asymmetry of the blowing process will increase requiring adapted heating and/or blowing pressure profiles. FIGS. 4a and 4b show the relationship between the original preform located within a mould having the inner form of the part subject generated by stretch blow moulding. The preform is shown in FIG. 4a as dashed lines located with respect to the mould and hence with respect to the final basic container with the preform at an angle of 75.5° with respect to the bottom plane of the basic container. In a preferred embodiment the average material blowing ratio on each side of the mid-line of the preform is the same—or at least within 50% the same even though the final product on each side of this mid-line are not identical. If one side has to be blown much more than another, then the wall thickness will be determined by the most heavily blown section. If an equal thickness (and ideally minimum thickness) is to be achieved then the blowing must be rather uniform in mutually opposed direction starting from the mid-line of the preform. From the original position shown in FIGS. 4a and b, the core of preform is preferably forced down towards the bottom in the moulding process thus causing a stretching in a direction perpendicular to the stretching in the blowing direction. This creates a biaxially stretched wall of the container which increases the strength and toughness of that wall. Also the core can be straight—there is no need for a core that is bent near the top surface of the basic container.

According to a second embodiment of the basic container, according to the present invention, the container head is eccentric with respect to the top.

According to a third embodiment of the basic container, according to the present invention, the basic container consists essentially of a biaxially stretched polymer.

According to a fourth embodiment of the basic container, according to the present invention, the biaxially stretched polymer is a polyester, with a polyester consisting essentially of polyethylene terephthalate being preferred.

According to a fifth embodiment of the basic container, according to the present invention, the top comprises at least one lip adapted to receive an object by elastically clamping.

According to a sixth embodiment of the basic container, according to the present invention, the top comprises at least one indentation adapted to accept a click hook.

According to a seventh embodiment of the basic container, according to the present invention, the basic container is obtained by a process comprising the steps of: injection moulding a preform comprising the container head; placing the preform in a mould at an acute angle with respect to the preform; axially stretching the non-container head part of the preform to the bottom of the mould; blow moulding the stretched part of the preform to the mould to provide the basic container.

According to an eighth embodiment of the basic container, according to the present invention, the basic container is weld-less.

According to a ninth embodiment of the basic container, according to the present invention, the basic container is seamless.

According to a tenth embodiment of the basic container, according to the present invention, a figure of merit (FOM) given by the expression: (W×TS^{1/2})/V where W is the weight of the basic container in g, TS is the tensile strength of the material of the basic container in MPa and V is the volume included in the basic container is in the range of 160 to 350 g(MPa)^{1/2}/L with a FOM in the range of 200 to 325 g(MPa)^{1/2}/L being preferred.

Examples of basic containers, according to the present invention, are 5 L, 10 L and 20 L injection stretch blow moulded high density polyethylene containers with weights of 220-280 g, 380-500 g and 100-1200 g respectively; 5 L, 10 L and 20 L injection stretch blow moulded polyethylene terephthalate (PET) containers with weights of 110-160 g, 200-250 g and 400-600 g respectively; and 18.9 L (5 US gallon) injection stretch blow moulded polycarbonate (PC) containers with a weight of 675-725 g.

### Top Cup

Aspects of the present invention are realized by a top cup adapted to be attachable to the top of a basic container according to the present invention, without obstructing the filling/emptying opening of the container head of the basic container.

The top cup can be produced from any suitable polymer or polymers, e.g. including polyester, polypropylene, high density polyethylene and low density polyethylene

According to a first embodiment, according to the present invention, the top cup after attachment to the top of the basic container provides an upper surface substantially parallel to the bottom of the basic container.

According to a second embodiment, according to the present invention, the upper surface has at least one support point and/or at least one support rib.

According to a third embodiment, according to the present invention, the top cup further comprises at least one handle that can be encircled by at least one finger.

According to a fourth embodiment, according to the present invention, the top cup further comprises at least one hook protrusion to render the top cup attachable to the basic container.

According to a fifth embodiment, according to the present invention, the top further comprises a ring which when slipped over the container head ensures access to the basic container to the first user.

According to a sixth embodiment, according to the present invention, the top cup is obtained by an injection moulding process.

It is to be understood that although preferred embodiments, specific constructions and configurations, as well as materials, have been discussed herein for devices according to the present invention, various changes or modifications in form and detail may be made without departing from the scope and spirit of this invention.

1-21. (canceled)

22. A basic container formed by injection blow moulding or injection stretch blow moulding, comprising a top, a substantially flat bottom and at least three substantially flat sides extending at an angle of substantially 90° with respect to said bottom, said basic container being leak-free except for a container head in said top with a filling/emptying opening, wherein the axis of said container head is at an acute angle with respect to said bottom and wherein a figure of merit (FOM) given by the expression: (W×TS^{1/2})/V is in the range of 160 to 350 g(MPa)^{1/2}/L, where W is the weight of said basic container in g, TS is the tensile strength of the material of said basic container in MPa and V is the volume included in said basic container.

23. The basic container according to claim 22, wherein said container head is eccentric with respect to said top.

24. The basic container according to claim 22, wherein said basic container consists essentially of a biaxially stretched polymer.

25. The basic container according to claim 24, wherein said biaxially stretched polymer is a polyester.

26. The basic container according to claim 25, wherein said polyester consists essentially of polyethylene terephthalate.

27. The basic container according to claim 22, wherein said top comprises at least one lip adapted to receive an object by elastically clamping.

28. The basic container according to claim 22, wherein said top comprises at least one indentation adapted to accept a click hook.

29. A method of making a basic container according to claim 22, comprising the steps of: injection moulding a preform comprising the container head; placing said preform in a mould at an acute angle with respect to said preform; axially stretching said non-container head part of the preform to a bottom of said mould; blow moulding said stretched part of said preform to said mould to provide said basic container.

30. A process for manufacturing a basic container having a top, a substantially flat bottom and at least three substantially flat sides extending at an angle of substantially 90° with respect to said bottom, said basic container being leak-free except for a container head in said top with a filling/emptying opening, said process comprising the steps of: injection moulding a preform comprising said container head and a straight core; placing said preform in a mould, the inside of said mould having the form of said basic container and said preform being placed at an acute angle with respect to the part of said mould corresponding to said flat bottom with respect to said preform; axially stretching said non-container head part of the preform to the part of said mould corresponding to said bottom of said basic container bottom of said mould; blow moulding said stretched part of said preform to said mould to provide said basic container, wherein a figure of merit (FOM) given by the expression: (W×TS^{1/2})/V is in the range of 160 to 350 g(MPa)^{1/2}/L, where W is the weight of said basic container in g, TS is the tensile strength of the material of said basic container in MPa and V is the volume included in said basic container.

31. A top cup adapted to be attachable to the top of a basic container formed by injection blow moulding or injection stretch blow moulding, comprising a top, a substantially flat bottom and at least three substantially flat sides extending at an angle of substantially 90° with respect to said bottom, said basic container being leak-free except for a container head in said top with a filling/emptying opening, wherein the axis of said container head is at an acute angle with respect to said bottom and wherein a figure of merit (FOM) given by the expression: (W×TS^{1/2})/V is in the range of 160 to 350 g(MPa)^{1/2}/L, where W is the weight of said basic container in g, TS is the tensile strength of the material of said basic container in MPa and V is the volume included in said basic container without obstructing the filling/emptying opening of said container head of said basic container.

32. The top cup according to claim 31, wherein said top cup after attachment to said top of said basic container provides an upper surface extending substantially parallel to said bottom of said basic container.

33. The top cup according to claim 32, wherein said upper surface has at least one support point and/or at least one support rib.

34. The top cup according to claim 31, wherein said top cup further comprises at least one handle that can be encircled by at least one finger.

35. The top cup according to claim 31, wherein said top cup further comprises at least one hook protrusion to render said top cup attachable to said basic container.

36. The top cup according to claim 31, wherein said top further comprises a ring enabling the top to be slipped over said container head to provide access to said basic container to the first user.

37. The top cup according to claim 31, wherein said top cup is obtained by an injection moulding process.

38. A top cup adapted to be attachable to the top of a basic container produced according to the process of claim 30 without obstructing the filling/emptying opening of said container head of said basic container.

39. The top cup according to claim 38, wherein said top cup after attachment to said top of said basic container provides an upper surface substantially parallel to said bottom of said basic container.

40. The top cup according to claim 39, wherein said upper surface has at least one support point and/or at least one support rib.

41. The top cup according to claim 38, wherein said top cup further comprises at least one handle that can be encircled by at least one finger.

42. The top cup according to claim 38, wherein said top cup further comprises at least one hook protrusion to enable said top cup to be attached to said basic container.

43. The top cup according to claim 38, wherein said top further comprises a ring which when slipped over said container head enables access to said basic container to the first user.

44. The top cup according to claim 38, wherein said top cup is obtained by an injection moulding process.

45. A plastic container comprising a basic container formed by injection blow moulding or injection stretch blow moulding, comprising a top, a substantially flat bottom and at least three substantially flat sides extending at an angle of substantially 90° with respect to said bottom, said basic container being leak-free except for a container head in said top with a filling/emptying opening, wherein the axis of said container head is at an acute angle with respect to said bottom and wherein a figure of merit (FOM) given by the expression: (W×TS^{1/2})/V is in the range of 160 to 350 g(MPa)^{1/2}/L where W is the weight of said basic container in g, TS is the tensile strength of the material of said basic container in MPa and V is the volume included in said basic container, and a top cup adapted to be attachable to the top of said basic container attached with attachable means to said basic container, wherein said top cup does not obstruct the opening of said container head.

46. The plastic container according to claim 45, wherein said attaching means is gluing and/or at least one crimp connection and/or at least one shape-closed connection.

47. The plastic container according to claim 46, wherein said shape-closed connection is a click-connection.

48. The plastic container according to claim 45, wherein the basic container and top cup are made completely from PET material optionally with additives, optionally with colorants.

49. A plastic container comprising a basic container produced by the process of claim 30 and a top cup adapted to be attachable to the top of said basic container attached with attachable means to said basic container, wherein said top cup does not obstruct the opening of said container head.

50. The plastic container according to claim 49, wherein said attaching means is gluing and/or at least one crimp connection and/or at least one shape-closed connection.

51. The plastic container according to claim 50, wherein said shape-closed connection is a click-connection.

52. The plastic container according to claim 49, wherein the basic container and top cup are completely from PET material optionally with additives, optionally with colorants.
